(19) United States
(12) Patent Application Publication
(10) Pub. No.: US 2007/0242141 A1
(43) Pub. Date: Oct. 18, 2007

(54) Adjustable neutral density filter system for dynamic range compression from scene to imaging sensor

(75) Inventor: Florian Ciurea, San Jose, CA (US)

Correspondence Address: Jonathan O. Owens;HAVERSTOCK & OWENS LLP, 162 North Wolfe Road, Sunnyvale, CA, 94086, US

(73) Assignee: Sony Corporation and Sony Electronics Inc.

(21) Appl. No.: 11/404,653

(22) Filed: Apr. 14, 2006

(51) Int. Cl. H04N 5/262

(52) U.S. Cl. 348/239

(57) ABSTRACT

An apparatus and method that extend the graduated neutral density filter approach by implementing an in-camera adjustable neutral density filter are described. The adjustable neutral density filter is implemented by the means of a transmissive LCD. The transmissive LCD is controlled to form a mask image. This mask image is able to be computed using an acquired signal wherein the acquired signal is then inverted and blurred. In an embodiment, a splitter and an additional sensor are utilized to acquire a split signal and then modify the split signal for use as the mask image. The other split signal is filtered through the mask image and transmissive LCD. Images with a high dynamic range compression are ultimately captured.

### FIELD OF THE INVENTION

The present invention relates to the field of imaging. More specifically, the present invention relates to high dynamic range imaging.

### BACKGROUND OF THE INVENTION

Photography involves capturing a scene with a camera viewing the captured image is typically done on a monitor or printer. Dynamic range is defined as the contrast ratio of the brightest value to the darkest value that the medium, device or format is able to support without loss of detail.

Often, the dynamic range of a scene exceeds the dynamic range capability of an output device (e.g. a printer or monitor). The normal dynamic range of conventional printers is about 7-bits or 128:1 contrast ratio and the normal dynamic range of conventional monitors is about 8-bits of data or 256:1 contrast ratio. High dynamic range imaging involves capturing a greater dynamic range, and dynamic range compression involves the transformation of this higher dynamic range into a lower dynamic range, typically 8-bit or 256:1 contrast ratio.

Imaging devices also capture a finite range of intensities, and real world scenes frequently exceed this range. So, in reality, the problem of dynamic range compression is able to be broken into two main parts, dynamic range compression at capture and dynamic range compression at processing. FIG. 1 illustrates the various stages of dynamic range compression. An original scene 100 has the highest dynamic range, where the darkness of the earth versus the brightness of the sun are highly distinguishable. A captured scene 102, with dynamic range compression at the capture stage within the camera, shows the dynamic range is still relatively high such that the earth is still very dark while the sun is bright. Lastly, an output scene 104 at the output stage has the lowest dynamic range wherein the contrast of the earth and the sun is reduced.

Most methods for dynamic range compression focus on the dynamic range compression at processing, that is, how to compress the dynamic range of the imaging sensor to match that of the output device, which is typically seven or eight bits of data.

Traditionally, the photographers have been aware of the limited dynamic range of the imaging device and the need for dynamic range compression at the capture stage. In traditional photography, the problem is alleviated by the means of graduated neutral density filters. The filters come in various contrast levels and are designed to be used mostly for outdoor scenes or where the pattern of distribution of high contrast areas in a scene can be predicted. The graduated neutral density filters are round or square and are mounted on top of the front element of the camera. The main limitation of the graduated neutral density filters is the fact that they only model a predefined distribution of the high contrast areas in a scene.

U.S. Pat. No. 6,864,916 to Nayar et al. discloses apparatus and methods for obtaining high dynamic range images using a low dynamic range image sensor. The image of a scene is captured with an image sensor using a spatially varying exposure function. The spatially varying exposure function is implemented in a number of ways, such as by using as an optical mask with a fixed spatial attenuation pattern or by using an array of light sensing elements having spatially varying photosensitivities. The captured image is then normalized with respect to the spatially varying exposure function. The normalized image data is then interpolated to account for pixels that are either saturated or blackened to enhance the dynamic range of the image sensor.

U.S. Pat. No. 6,683,645 to Collins et al. discloses an imaging system that comprises an image detection unit and a filter unit. Pixel image signals are passed in parallel from the image detection unit to the filter unit. Circuit elements within each pixel generate pixel image signals with an amplitude that is proportional to the logarithm of the image intensity at that pixel. The filter unit carries out a spatial filtering operation and outputs the result.

### SUMMARY OF THE INVENTION

An apparatus and method that extend the graduated neutral density filter approach by implementing an in-camera adjustable neutral density filter are described. The adjustable neutral density filter is implemented by the means of a transmissive LCD. The transmissive LCD is controlled to form a mask image. This mask image is able to be computed using an acquired signal wherein the acquired signal is then inverted and blurred. In an embodiment, a splitter and an additional sensor are utilized to acquire a split signal and then modify the split signal for use as the mask image. The other split signal is filtered through the mask image and transmissive LCD. Images with a high dynamic range compression are ultimately captured.

In one aspect, an apparatus for acquiring one or more image signals of a scene comprising an imaging sensor for capturing the one or more image signals; and an internal filtering device coupled to receive a mask image from the imaging sensor, wherein the mask image is formed from the one or more image signals. The internal filtering device comprises a transmissive liquid crystal display. The apparatus is selected from the group consisting of a camera, a video camera, a camcorder, a digital camera, a cell phone and a PDA. The imaging sensor is selected from the group consisting of a charge-coupled device and a complementary metal-oxide-semiconductor. The mask image is formed by inverting and blurring the one or more signals.

In another aspect, an apparatus for acquiring a signal of a scene comprises a splitter for splitting the signal into a first split signal and a second split signal, a first imaging sensor for capturing a first split signal, a second imaging sensor for receiving the second split signal and generating a mask image and an internal filtering device for receiving the mask image and filtering the first split signal. The internal filtering device comprises a transmissive liquid crystal display. The apparatus is selected from the group consisting of a camera, a video camera, a camcorder, a digital camera, a cell phone and a PDA. The first imaging sensor and the second imaging sensor are selected from the group consisting of charge-coupled devices and complementary metal-oxide-semiconductors. The mask image is formed by inverting and blurring the second split signal. The signal is continuously acquired.

In yet another aspect, a method comprises generating a mask image from a first signal, forming the mask image on an internal filtering device and filtering a second signal using the mask image by passing the second signal through the internal filtering device displaying the mask image. The internal filtering device comprises a transmissive liquid crystal display. The generating and filtering occurs within an imaging device. The imaging device is selected from the group consisting of a camera, a video camera, a camcorder, a digital camera, a cell phone and a PDA. The method further comprises acquiring the first signal from a scene. The method further comprises receiving the first signal on an imaging sensor. The method further comprises acquiring the second signal from the scene. The method further comprises capturing the filtered second signal on an imaging sensor. The method further comprises generating the mask image which includes inverting and blurring the first signal. The first signal and the second signal are acquired at different times. The first signal and the second signal are continuously acquired.

In an another aspect, a method comprises acquiring a first signal from a scene, receiving the first signal on an imaging sensor, modifying the first signal into a mask image, forming the mask image on an internal filtering device, acquiring a second signal from the scene, filtering the second signal and capturing the filtered second signal on the imaging sensor. The internal filtering device comprises a transmissive liquid crystal display. The method occurs within an imaging device. The imaging device is selected from the group consisting of a camera, a video camera, a camcorder, a digital camera, a cell phone and a PDA. Modifying the first signal includes inverting and blurring. The imaging sensor is selected from the group consisting of a charge-coupled device or a complementary metal-oxide-semiconductor. The first signal and the second signal are acquired at different times. The first signal and the second signal are continuously acquired. Filtering occurs as the second signal passes through the internal filtering device with the mask image.

In yet another aspect, a method comprises acquiring a signal from a scene, splitting the signal into a first split signal and a second split signal, receiving the second split signal at a second imaging sensor, modifying the second split signal into a mask image, forming the mask image on an internal filtering device, filtering the first split signal and capturing the filtered first split signal on a first imaging sensor. The internal filtering device comprises a transmissive liquid crystal display. The method occurs within an imaging device. The imaging device is selected from the group consisting of a camera, a video camera, a camcorder, a digital camera, a cell phone and a PDA. Modifying the signal includes inverting and blurring. The first imaging sensor and the second imaging sensor are selected from the group consisting of charge-coupled devices or complementary metal-oxide-semiconductors. The signal is continuously acquired. Filtering occurs as the first split signal passes through the internal filtering device with the mask image.

### BRIEF DESCRIPTION OF THE DRAWINGS

FIG. 1 illustrates the various stages of dynamic range of an image from capture processing.

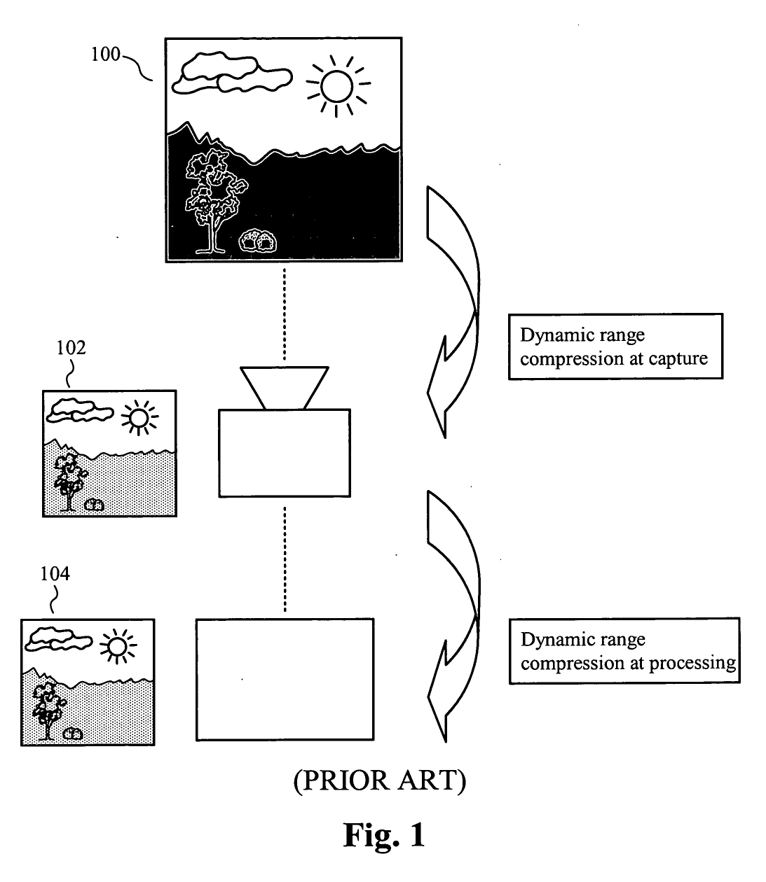

FIG. 2 illustrates an embodiment of a system implementing an in-camera adjustable neutral density filter.

FIG. 3 illustrates a flowchart of an embodiment of implementing an in-camera adjustable neutral density filter.

FIG. 4 illustrates an embodiment of a system implementing an in-camera adjustable neutral density filter.

FIG. 5 illustrates a flowchart of an embodiment of implementing an in-camera adjustable neutral density filter.

### DETAILED DESCRIPTION OF THE PREFERRED EMBODIMENT

An apparatus and method that extend a graduated neutral density filter approach by implementing an in-camera adjustable neutral density filter are described. The adjustable neutral density filter is implemented by the means of a transmissive Liquid Crystal Display (LCD). The transmissive LCD is controlled to form a luminance mask, or a distribution of inverse luminance variation of the image. The luminance mask is able to be computed in various ways, similar to the way a luminance mask is computed in methods for dynamic compression at the processing stage.

By the method disclosed herein, the resulting image captured by the imaging sensor is a ratio between the scene and the mask image:
Sensor-image=Scene-image/Mask-image
The mask image “Mask-image” implements the adjustable graduated neutral density filter. It is computed from an estimated “Scene-image” by inverting the result from gaussian blurring. An alternative to the standard gaussian blurring is to use an edge-preserving blurring such as the median filter or bilateral filter. Additionally, other methods for computing the Mask-image are able to be employed.

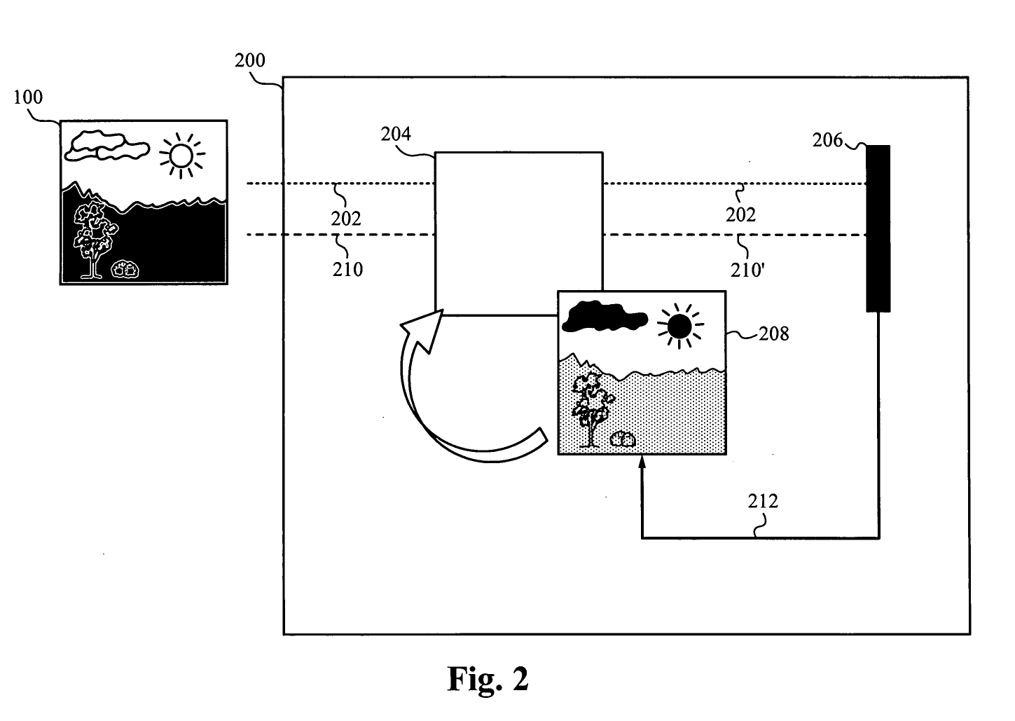

FIG. 2 illustrates an embodiment of a system implementing an in-camera adjustable neutral density filter. The scene 100 is captured by an imaging device 200, such as a camera or camcorder. A first signal 202 of the scene 100 enters the camera 200 and passes through a transmissive LCD 204. Initially, the transmissive LCD 204 is transparent, so that the first signal 202 passes through unaffected. The first signal 202 is captured by an imaging sensor 206 such as a Charge-Coupled Device (CCD), a Complementary Metal-Oxide-Semiconductor (CMOS) or other imaging sensor device. The first signal 202 is then processed such that it is modified to an inverted signal 212, meaning dark areas of the image become light and light areas become dark. The inverted signal 212 is also slightly blurred. The inverted signal 212 is a mask image 208 which is sent to the transmissive LCD 204. Before a shutter (not shown) is released, the mask image 208 is formed on the transmissive LCD 204 from the continuously updated image that is formed on the imaging sensor 206. Upon releasing the shutter (not shown), the transmissive LCD 204 reflects the mask image 208. The scene 100 is then captured again by the camera such that a second signal 210 passes through the transmissive LCD 204 with the mask image 208. The second signal 210 becomes a filtered signal 210′ after it is filtered through the mask image 208 on the transmissive LCD 204. The imaging sensor 206 then captures the filtered signal 210′.

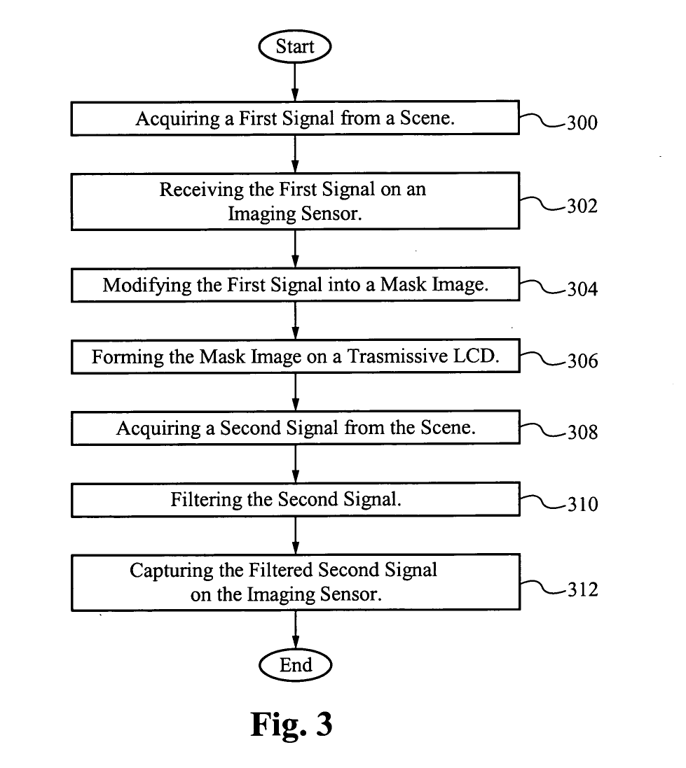

FIG. 3 illustrates a flowchart of an embodiment of implementing an in-camera adjustable neutral density filter. In the step 300, a first signal is acquired from a scene. The first signal passes through a transmissive LCD and is received on an imaging sensor in the step 302. In the step 304, the first signal is modified into a mask image. The modifications include inversion, blurring and other necessary changes if any. The mask image is then formed on the transmissive LCD in the step 306. In the step 308, a second signal is acquired from the scene. The second signal is filtered in the step 310. The filtering is performed as the second signal passes through the transmissive LCD and the mask image. In the step 312, the filtered second signal is captured on the imaging sensor. The steps of acquiring a first signal are repeated as necessary to determine the best mask image to capture an image with the best overall contrast and dynamic range compression.

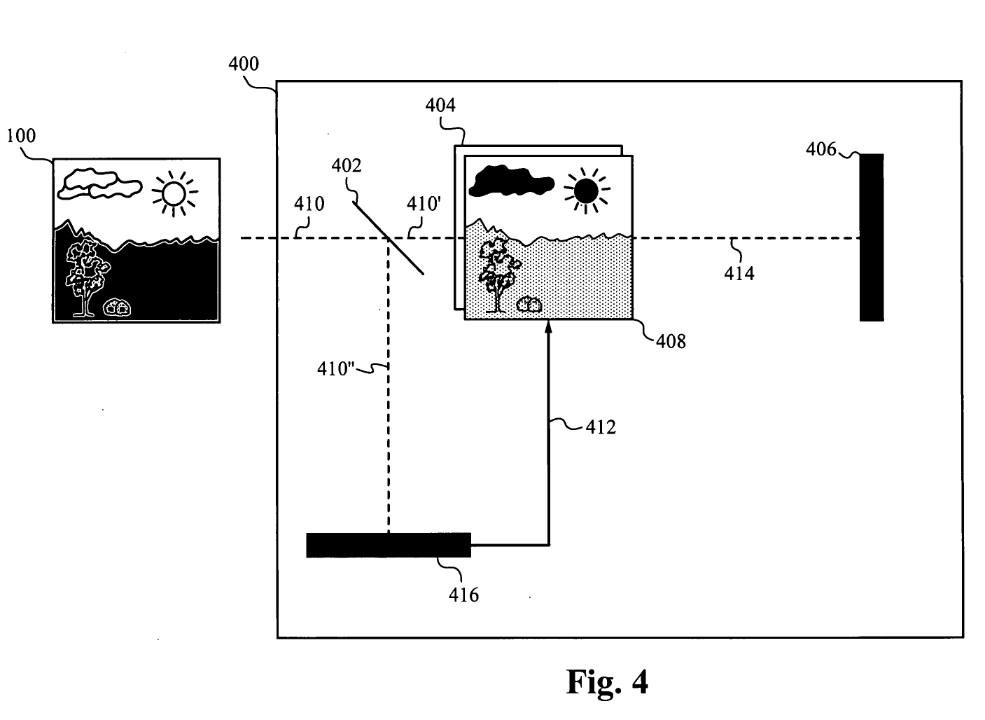

FIG. 4 illustrates an embodiment of a system implementing an in-camera adjustable neutral density filter. The scene 100 is captured by an imaging device 400, such as a camera or camcorder. A signal 410 of the scene 100 enters the camera 400 and is split by a splitter 402. The signal 410 is continuously acquired. The splitter 402 splits the signal 410 into two split signals 410′ and 410″. The first split signal 410′ is directed towards a transmissive LCD 404. Initially, the transmissive LCD 404 is clear as no mask image is formed on it. After a very short period of time, a mask image 408 is formed on the transmissive LCD 404. As the first split signal 410′ passes through the transmissive LCD 404 with the mask image 408, it is filtered and then goes to a first imaging sensor 406, such as a CCD, CMOS or other imaging sensors. The second split signal 410″ is directed towards a second imaging sensor 416 wherein the second split signal 410″ is modified such that it is inverted and blurred into an inverted signal 412. The inverted signal 412 is formed on the transmissive LCD 404 as the mask image 408. The mask image 408 produced by the second sensor 416 is the mask image 408 that the first split signal 410′ passes through on its way to the first imaging sensor 406. After the first split signal 410′ passes through the transmissive LCD 404 with the mask image 408, the first split signal 410′ is filtered into a filtered signal 414 which is the captured image. The strength of the mask image 408 that is estimated from the second imaging sensor 416 is able to be adjusted in real time such that the resulting image that is being formed on the first imaging sensor 406 has the best overall contrast and dynamic range compression.

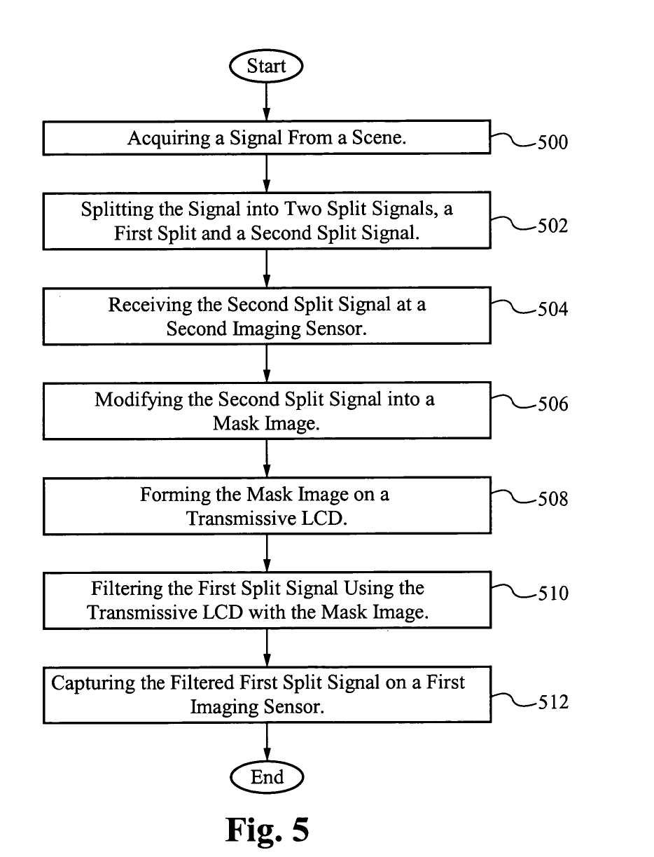

FIG. 5 illustrates a flowchart of an embodiment of implementing an in-camera adjustable neutral density filter. In the step 500, a signal is acquired from a scene. The signal is continuously acquired. In the step 502, the signal is then split into two split signals, a first split signal and a second split signal. In the step 504, the second split signal is received at a second imaging sensor. The second split signal is modified into a mask image in the step 506. In the step 508, the mask image is formed on a transmissive LCD. The first split signal is then filtered using the transmissive LCD with the mask image. In the step 510, the filtered first split signal is captured on a first imaging sensor. The captured first split signal is the image with the desired contrast and dynamic range compression.

To utilize the in-camera adjustable neutral density filter, a user generally uses an imaging device implementing the filter as he would use any other imaging device. In an embodiment, a first image is acquired to be used as a mask, and a second image is then filtered using that mask. The first image signal passes through the transmissive LCD without any filtering since there is no mask yet. The first image signal is received by an imaging sensor and is then manipulated into the mask image. The mask image is formed by inverting the first image signal by modifying the dark areas of the first image signal to light areas, modifying the light areas of the first image signal to dark areas and slightly blurring the image. Multiple signals are able to be acquired and utilized as masks to determine the best mask configuration. The mask image is then formed on the transmissive LCD, so that when the second image signal is acquired, it passes through the transmissive LCD with the mask. This allows the captured image to have a high dynamic range compression.

In an embodiment, an imaging device utilizes two imaging sensors. However, only one signal needs to be acquired. The signal is continuously received while the shutter is open. The signal is split into two split signals, a first split signal and a second split signal. The second split signal is received by a second sensor and modified by inverting and blurring it. The modified image is used as the mask image and is formed on a transmissive LCD. The first split signal then passes through the transmissive LCD with the mask image from the second split signal and is filtered. The filtered first split signal is then captured on a first sensor. The filtered first split signal is an image with compressed dynamic range.

In operation, the imaging devices that implement an in-camera adjustable neutral density filter appear the same or very similar to imaging devices that do not. However, most cameras that have some form of neutral density filter require additional exterior attachments such as extra lenses that are manually attached. Prior cameras that had internal neutral density filters utilized a plurality of lenses which are moved within the device as selected. Unlike the prior devices, the system described herein does not need a plurality of physical filters, as only one internal transmissive LCD with a mask image is used. Furthermore, prior devices do not include a method of obtaining a mask image from an acquired image and then using that as part of the filter, wherein the invention described herein does. Unlike the invention described, prior devices also do not implement multiple sensors and a splitter where a mask image is generated from a single image to be used to filter the other split signal. Additionally, past filters had a pre-defined mask, wherein the filter described herein is not limited to a pre-defined mask.

The imaging device described above is able to be a camera, a video camera, a camcorder, a digital camera, a cell phone, a PDA and any other device that would benefit from the aforementioned methods.

The system is able to improve the quality of captured images significantly in high dynamic range (high contrast) scenes and has applications to general video/still cameras and other imaging devices. Surveillance cameras are able to benefit from the system in conditions of backlight illumination (high contrast scenes) or when placed in other types of scenes with high dynamic range.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. An apparatus for acquiring one or more image signals of a scene comprising:
a. an imaging sensor for capturing the one or more image signals; and
b. an internal filtering device coupled to receive a mask image from the imaging sensor, wherein the mask image is formed from the one or more image signals.

2. The apparatus as claimed in claim 1 wherein the internal filtering device comprises a transmissive liquid crystal display.

3. The apparatus as claimed in claim I wherein the apparatus is selected from the group consisting of a camera, a video camera, a camcorder, a digital camera, a cell phone and a PDA.

4. The apparatus as claimed in claim 1 wherein the imaging sensor is selected from the group consisting of a charge-coupled device and a complementary metal-oxide-semiconductor.

5. The apparatus as claimed in claim 1 wherein the mask image is formed by inverting and blurring the one or more signals.

6. An apparatus for acquiring a signal of a scene comprising:
a. a splitter for splitting the signal into a first split signal and a second split signal;
b. a first imaging sensor for capturing a first split signal;
c. a second imaging sensor for receiving the second split signal and generating a mask image; and
d. an internal filtering device for receiving the mask image and filtering the first split signal.

7. The apparatus as claimed in claim 6 wherein the internal filtering device comprises a transmissive liquid crystal display.

8. The apparatus as claimed in claim 6 wherein the apparatus is selected from the group consisting of a camera, a video camera, a camcorder, a digital camera, a cell phone and a PDA.

9. The apparatus as claimed in claim 6 wherein the first imaging sensor and the second imaging sensor are selected from the group consisting of charge-coupled devices and complementary metal-oxide-semiconductors.

10. The apparatus as claimed in claim 6 wherein the mask image is formed by inverting and blurring the second split signal.

11. The apparatus as claimed in claim 6 wherein the signal is continuously acquired.

12. A method comprising:
a. generating a mask image from a first signal;
b. forming the mask image on an internal filtering device; and
c. filtering a second signal using the mask image by passing the second signal through the internal filtering device displaying the mask image.

13. The method as claimed in claim 12 wherein the internal filtering device comprises a transmissive liquid crystal display.

14. The method as claimed in claim 12 wherein the generating and filtering occurs within an imaging device.

15. The method as claimed in claim 14 wherein the imaging device is selected from the group consisting of a camera, a video camera, a camcorder, a digital camera, a cell phone and a PDA.

16. The method as claimed in claim 12 further comprising acquiring the first signal from a scene.

17. The method as claimed in claim 12 further comprising receiving the first signal on an imaging sensor.

18. The method as claimed in claim 12 further comprising acquiring the second signal from the scene.

19. The method as claimed in claim 12 further comprising capturing the filtered second signal on an imaging sensor.

20. The method as claimed in claim 12 wherein generating the mask image includes inverting and blurring the first signal.

21. The method as claimed in claim 12 wherein the first signal and the second signal are acquired at different times.

22. The method as claimed in claim 12 wherein the first signal and the second signal are continuously acquired.

23. A method comprising:
a. acquiring a first signal from a scene;
b. receiving the first signal on an imaging sensor;
c. modifying the first signal into a mask image;
d. forming the mask image on an internal filtering device;
e. acquiring a second signal from the scene;
f. filtering the second signal; and
g. capturing the filtered second signal on the imaging sensor.

24. The method as claimed in claim 23 wherein the internal filtering device comprises I transmissive liquid crystal display.

25. The method as claimed in claim 23 wherein the method occurs within an imaging device.

26. The method as claimed in claim 25 wherein the imaging device is selected from the group consisting of a camera, a video camera, a camcorder, a digital camera, a cell phone and a PDA.

27. The method as claimed in claim 23 wherein modifying includes inverting and blurring.

28. The method as claimed in claim 23 wherein the imaging sensor is selected from the group consisting of a charge-coupled device or a complementary metal-oxide-semiconductor.

29. The method as claimed in claim 23 wherein the first signal and the second signal are acquired at different times.

30. The method as claimed in claim 23 wherein the first signal and the second signal are continuously acquired.

31. The method as claimed in claim 23 wherein filtering occurs as the second signal passes through the internal filtering device with the mask image.

32. A method comprising:
a. acquiring a signal from a scene;
b. splitting the signal into a first split signal and a second split signal;
c. receiving the second split signal at a second imaging sensor;
d. modifying the second split signal into a mask image;
e. forming the mask image on an internal filtering device;
f. filtering the first split signal; and
g. capturing the filtered first split signal on a first imaging sensor.

33. The method as claimed in claim 32 wherein the internal filtering device comprises a transmissive liquid crystal display.

34. The method as claimed in claim 32 wherein the method occurs within an imaging device.

35. The method as claimed in claim 34 wherein the imaging device is selected from the group consisting of a camera, a video camera, a camcorder, a digital camera, a cell phone and a PDA.

36. The method as claimed in claim 32 wherein modifying includes inverting and blurring.

37. The method as claimed in claim 32 wherein the first imaging sensor and the second imaging sensor are selected from the group consisting of charge-coupled devices or complementary metal-oxide-semiconductors.

38. The method as claimed in claim 32 wherein the signal is continuously acquired.

39. The method as claimed in claim 32 wherein filtering occurs as the first split signal passes through the internal filtering device with the mask image.
